(19) United States
(12) Patent Application Publication
(10) Pub. No.: US 2022/0220575 A1
(43) Pub. Date: Jul. 14, 2022

(54) Steel for a Sawing Device

(71) Applicant: HUSQVARNA AB, HUSKVARNA (SE)

(72) Inventor: Adam Ståhlkrantz, Stockholm (SE)

(21) Appl. No.: 17/610,609

(22) PCT Filed: May 6, 2020
(86) PCT No.: PCT/SE2020/050466

§ 371 Date: Nov. 11, 2021

(30) Foreign Application Priority Data
May 17, 2019 (SE) 1950588-2

(51) Int. Cl. C21D 9/24; B27B 33/14; C22C 38/40; C22C 38/06; C22C 38/04; C22C 38/02; C22C 38/00; C21D 6/00

(52) U.S. Cl. CPC C21D 9/24; B27B 33/142; C22C 38/40; C22C 38/06; C22C 38/04; C21D 2211/002; C22C 38/002; C21D 6/008; C21D 6/005; C21D 6/004; C21D 2211/008; C22C 38/02

(57) ABSTRACT

A steel for a sawing device (100) containing in wt. %: C: 0.7-1.2 Mn: 0.3-0.7 Cr: 0-1.05 Ni: 0-1.5 Al: 0-0.5 Si: 0-0.5 wherein the total amount of C, Mn, Cr, Ni, Al, and Si is 1.5-4.5 wt. % and the balance being Fe and incidental elements and wherein the microstructure of the steel alloy is bainitic or a mixture of bainite and martensite with dispersed Fe₃C-particles.

### TECHNICAL FIELD

The present disclosure relates to a steel for a sawing device having at least one cutting tooth, in particular for a cutting link of a saw chain.

### BACKGROUND ART

Sawing chains for chain saws are subject to wear during sawing. The wear is typically concentrated to the cutting links of the sawing chain. To increase the wear resistance and thereby the life-length of the sawing chain, the links of the sawing chain may be subjected to various types of surface hardening or be coated with wear resistant coatings.

However, it has shown that known sawing chains do not have sufficient operational life-length to meet the demands on efficiency and low cost in forestry work.

Thus it is an object of the present disclosure to provide a steel which solves at least one of the problems of the prior-art.

In particular, it is an object of the present disclosure to provide a steel which allows for manufacturing of sawing devices that may be used for long time.

### SUMMARY OF THE INVENTION

A steel for a sawing device containing in wt. %:

| | |
|---|---|
| C: | 0.7-1 2 |
| Mn: | 0.2-0.8 |
| Cr: | 0-1.0 |
| Ni: | 0-1.5 |
| Al: | 0-0.5 |
| Si: | 0-0.5 |

balance Fe and incidental elements, wherein the total amount of C, Mn, Cr, Ni, Al and Si is 1.5-4.5 wt. % and wherein the microstructure of the steel is bainitic or a mixture of bainite and martensite with dispersed Fe₃C-particles.

The advantage of the steel according to the present disclosure is that it exhibits a very good tempering resistance. Thus, when the steel is reheated after hardening its hardness decreases only little. This feature allows for several advantages. For example, a sawing device manufactured from the steel may be coated with wear resistant coatings at elevated temperatures, and/or be subjected to other process-steps that are performed at elevated temperatures, without significant hardness loss. A sawing device manufactured from the steel may further be operated to high temperatures during sawing without losing hardness.

In the following the steel according to the present disclosure may be denominated “the steel” to not burden the text unnecessary. In the present disclosure, “the steel” may also be denominated the “the steel alloy”.

The good tempering resistance of the steel is not known in detail but it has been confirmed in comparative experiments which will be described later in the description.

The steel comprises the following alloy elements.

Carbon (C) is present in the steel in an amount of 0.7-1.2 wt. %. The high carbon content results in a matrix of bainite or a mixture of bainite and martensite with a high density of dispersed Fe₃C particles in both cases. FIG. 2 shows a sample of the steel in 5000× magnification showing a bainite/martensite matrix in gray with white Fe₃C-particles. The large number of Fe₃C-particles contribute to particle hardening in the steel alloy. The large surface energy provided by the high amount of Fe₃C-particles may also contribute to increase the hardness in the steel. The content of C should be 0.7 wt. % or higher to provide sufficient tempering resistance. A carbon content above 1.2 wt. % results in that the steel becomes too hard to machine. The carbon content may be 0.8-1.1 wt. % which is a good combination of hardness and workability. A carbon content of 0.9-1.1 results in high hardness and high tempering resistance.

Manganese (Mn). The steel alloy comprises 0.2-0.8 wt. % manganese. Manganese improves hardenability of the steel alloy and results in high strength and hardness after hardening or the steel alloy. High amounts of manganese may result in high hardenability of the steel alloy which increases the production costs due to long isothermal transformation temperatures. That is, the transformation into a bainite/martensite matrix takes too long time. Low contents of manganese may result in low hardenability and unwanted phases in the hardened steel alloy after isothermal transformation. Thus, unwanted precipitations during quenching may occur. A manganese content of 0.3-0.7 wt. % achieves good hardenability at low cost.

Chromium (Cr) stabilizes carbides and is therefore an important optional element for maintaining a high density of Fe₃C-particles in the matrix of the steel. Chromium also improves hardenability. The amount of chromium may be 0-0.5 wt. %, 0-0.7 wt. %, 0-1.0 wt. %, 0.1-1.0 wt. %, 0.02-0.5 wt. % or 0.5-1.0 wt. %.

Nickel (Ni) improves toughness of the steel and may be present in an amount of 0-1.5 or 0.02-1.0 wt. %. An amount of nickel from 0.5 wt. % gives good toughness. However, nickel is expensive and therefore the nickel may be 0.5-1.0 wt. %.

Silicon (Si) and Aluminum (Al) both contribute to hardenability and may optionally be included in the steel according to present disclosure. Silicon may thereby be present in an amount from 0-0.5 wt. % or 0.02-0.5 wt. %. Alternatively, silicon may be 0-0.3 wt. % or 0.02-0.3 wt. %. Aluminum may be present in an amount of 0-0.5 wt. % or 0.001-0.5 wt. %. Alternatively, aluminum may be 0-0.3 wt. % or 0.001-0.3 wt. %. Preferably, the total content of aluminum and silicon is less than 0.6 wt. %.

The total sum of the elements C, Mn, Cr, Ni, Si and Al is 1.5-4.5 wt % in the steel alloy. The lower limit of 1.5 wt. % is set to achieve sufficient hardenability. The upper limit is set to avoid long transformation times into the bainite/martensite matrix. The total sum of the elements C, Mn, Cr, Ni, Si and Al in the steel may be 1.5-4.5 wt. % thereby achieving a well-balanced relationship between good hardenability and short transformation time. In an embodiment, the total sum of the elements C, Mn, Cr, Ni, Si and Al may be 2-5 wt. % in the steel alloy.

The steel according to the present disclosure may further comprise incidental elements. The incidental elements may be alloy elements that have negligible or insignificant influence on the properties of the steel. The incidental elements may in some instances be considered impurities. Non-limiting examples of incidental elements are: Vanadium (V), Titanium (Ti), Neodymium (Nd). Non-limiting examples of other incidental elements which may be considered impurities are Hydrogen (H), Boron (B), Nitrogen (N), Oxygen (O), Phosphorous (P), Sulphur (S). The total amount of incidental elements should not exceed 0.5 wt. %.

The term “matrix” is synonymous to the microstructure of the steel.

The present disclosure also relates to a sawing device manufactured from the above disclosed steel.

The present disclosure also relates to a method of manufacturing a sawing device.

### BRIEF DESCRIPTION OF THE DRAWINGS

FIG. 1a, 1b: Diagrams showing hardness of the steel before and after tempering.

FIG. 2: A photograph in 5000× magnification of a sample of the steel according to the present disclosure.

FIG. 3: A diagram showing hardness decrease after 1 h tempering of the steel.

FIG. 4: A diagram showing hardness decrease after high temperature tempering of the steel according to the present disclosure.

FIG. 5: A diagram showing hardness decrease after tempering the steel of the present disclosure for increasing time periods.

FIG. 6: A schematic drawing of a sawing device according to the present disclosure.

FIG. 7: A flowchart showing a method for manufacturing the sawing device according to the present disclosure.

### DESCRIPTION OF EXAMPLES

The steel according to the present disclosure is in the following described with reference to the following non-limiting examples.

Samples of the steel were prepared by conventional steel making methods. A comparative sample S1* was prepared and then inventive samples S2-S4 were prepared having a varying carbon content within the composition of the comparative sample S1*.

The samples had the following compositions:

TABLE 1

| | Wt. % | | | | | | | | |
|---|---|---|---|---|---|---|---|---|---|
| | C | Mn | Cr | Ni | Al | Si | P | S | Fe |
| S1* | 0.62 | 0.36 | 0.10 | 0.9 | 0.004 | 0.21 | 0.009 | 0.0007 | Bal. |
| S2 | 0.73 | 0.36 | 0.10 | 0.9 | 0.004 | 0.21 | 0.009 | 0.0007 | Bal. |
| S3 | 0.79 | 0.36 | 0.10 | 0.9 | 0.004 | 0.21 | 0.009 | 0.0007 | Bal. |
| S4 | 0.89 | 0.36 | 0.10 | 0.9 | 0.004 | 0.21 | 0.009 | 0.0007 | Bal. |

(S1* is a comparative sample with low carbon content.)

The samples were hardened by heating the samples above the austenitization temperature followed by cooling to an isothermal temperature to obtain a bainite/martensite matrix with dispersed Fe₃C particles.

The hardness of the hardened samples was measured in HV1 and are shown in the diagram 1a.

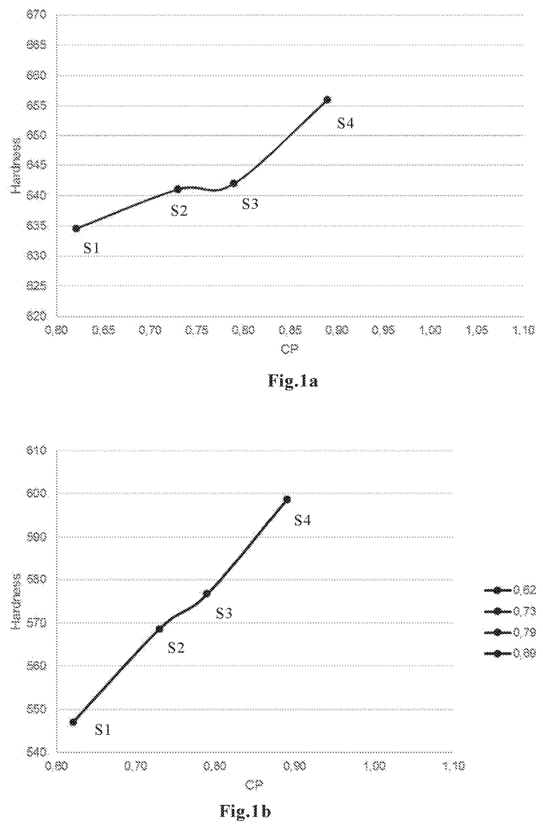

Next, the hardened samples were tempered at a temperature of 300° C. for 1 hour. The hardness of the samples was measured again. The hardness of the samples is shown in FIG. 1b.

From the initial hardness measurements shown in FIGS. 1a and 1b it is clear that the hardness increases with increasing carbon content, this is also true from the hardness after tempering for 1 h.

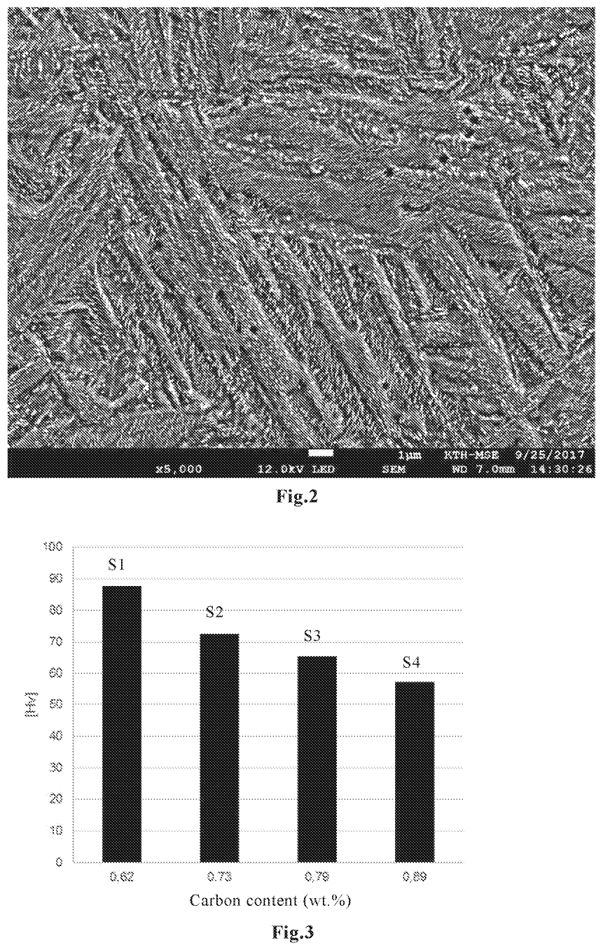

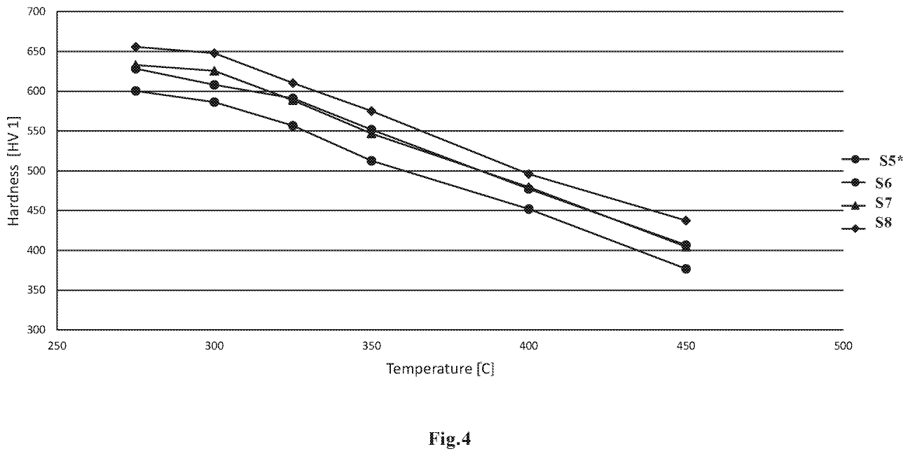

FIG. 3 shows the decrease in hardness of each hardened sample after tempering. Surprisingly, the decrease in hardness is smaller for the samples 2-4 with higher carbon content than for the low carbon comparative sample 1. Thus, higher carbon content slows the decrease in hardness during tempering.

A further study was made on samples of the steel according to the present disclosure. A comparative sample S5* was prepared together with inventive samples S6-S8. The compositions of the samples are shown in table 2.

TABLE 2

| | Wt. % | | | | | | | | |
|---|---|---|---|---|---|---|---|---|---|
| | C | Mn | Cr | Ni | Al | Si | P | S | Fe |
| S5* | 0.61 | 0.36 | 0.10 | 0.9 | 0.004 | 0.21 | 0.009 | 0.0007 | Bal. |
| S6 | 0.72 | 0.66 | 0.23 | 0.03 | 0.033 | 0.24 | 0.001 | 0.001 | Bal. |
| S7 | 0.816 | 0.47 | 0.095 | 0.056 | 0.020 | 0.164 | 0.009 | 0.0006 | Bal. |
| S8 | 0.99 | 0.43 | 0.2 | 0.051 | 0.005 | 0.234 | 0.009 | 0.0006 | Bal. |

(S5* is a comparative sample with low carbon content.)

The samples were hardened by heating the samples above the austenitization temperature followed by cooling to an isothermal temperature to obtain a bainite/martensite matrix with dispersed Fe₃C particles.

Samples having the composition shown in table 2 were thereafter subjected to tempering. The samples were thereby heated in a furnace to various specific temperatures in the range of 275-450° C., held for 1 hour at the specific temperature. Subsequently, the samples were removed from the furnace and allowed to cool to room temperature. Hardness testing at HV1 was subsequently performed at room temperature.

The result of the high temperature tempering hardness testing is shown in FIG. 4. As can be seen in FIG. 4 the carbon has a large effect on the tempering properties over a large tempering range, further, the influence of higher amount of alloying addition is also shown in by comparing S6 and S7 where S6 have lower carbon while S7 have slightly higher alloying addition highlighting the influence and importance of the combination of both carbon as well as additional alloying elements,

Samples having the composition shown in table 2 were also subjected to tempering at constant temperature during an increasing period of time. The samples were thereby heated to 300° C. in a furnace and periodically removed from the furnace after a predetermined period of time and allowed to cool to room temperature. Hardness testing of each sample was performed at room temperature at HV1.

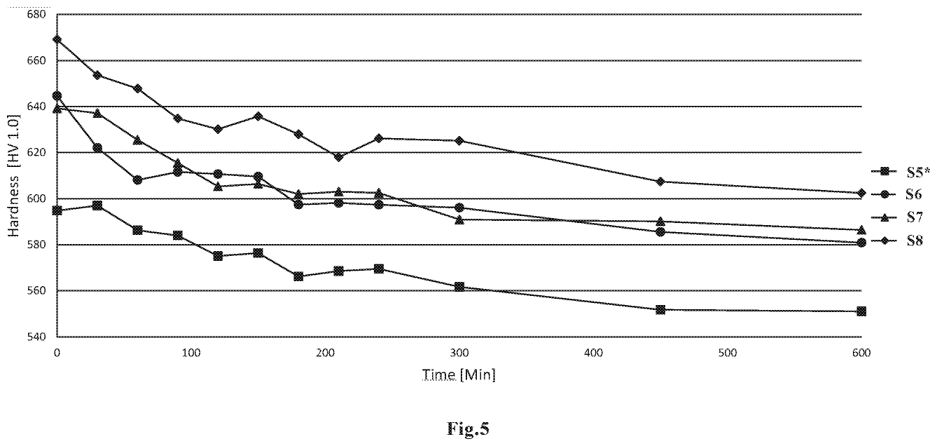

The result of the hardness testing is shown in FIG. 5. As was earlier described for FIG. 4 similar effects are seen during a prolonged isothermal tempering thus highlighting the improvement of desired tempering properties where carbon is a key element.

The isothermal temperature at sample preparation was in the range at or above the Ms-temperature and the samples were kept at this temperature for about 1 hour after which the samples where quenched in order to obtain a bainite/martensite matrix.

### DETAILED DESCRIPTION OF EMBODIMENTS

FIG. 5 shows schematically a sawing device 1 having at least one cutting tooth 2 according to an aspect of the present disclosure. The sawing device is typically configured for wood sawing and for use in a handheld motor driven sawing apparatus (not shown). In FIG. 5, the sawing device is exemplified as a cutting link for a sawing chain 3 of a chainsaw. However, also other sawing devices are feasible, for example reciprocating sawblades or circular sawblades. Other sawing apparatuses are also feasible, for example clearing saws. The sawing device may comprise a wear resistant coating on at least a portion of its outer surface, for example chromium.

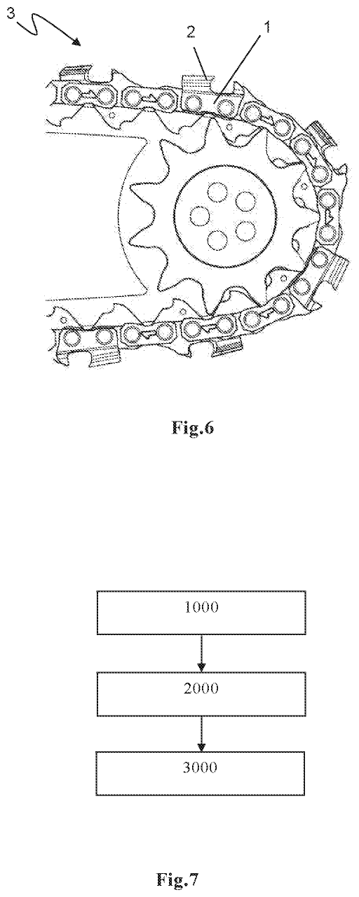

FIG. 6 shows schematically the steps of a method for manufacturing the sawing device according to the present disclosure.

In a first step 1000 a sawing device provided. The sawing device is manufactured by conventional metal and machining operations from a steel according to the present disclosure as described above.

In a second step 2000 the sawing device is hardened by heating the sawing device to the austenitization temperature followed by rapid cooling to an isothermal temperature. The isothermal temperature may be at or above the Ms-temperature for the steel composition of the sawing device. The sawing device is thereby held in the temperature range at or above Ms and kept for a predetermined time, such as about 1 hour, after which it is cooled to room temperature to obtain a microstructure of bainite or bainite/martensite with dispersed Fe₃C-particles. The heat treatment parameters, i.e. austenitization temperature, cooling speed and the isothermal temperature vary in dependency of the composition of the steel of the sawing device and may be determined by the skilled person by look-up tables, practical trials or by commercially available modeling computer programs. Cooling may for example be performed in air, oil, salt or water. The microstructure of the samples may be evaluated by microscopy.

In a third step 3000 a wear resistant coating is applied onto at least a portion of the surface of the sawing device.

1. A sawing device comprising steel containing in wt. %:

| | |
|---|---|
| C: | 0.7-1.2 |
| Mn: | 0.2-0.8 |
| Cr: | 0-1.0 |
| Ni: | 0-1.5 |
| Al: | 0-0.5 |
| Si: | 0-0.5 |

wherein the total amount of C, Mn, Cr, Ni, Al, and Si is 1.5-4.5 wt. % and the balance being Fe and incidental elements and wherein the microstructure of the steel alloy is bainitic or a mixture of bainite and martensite with dispersed Fe₃C-particles.

2. The sawing device according to claim 1, wherein the amount of C is 0.8-1.1.

3. The sawing device according to claim 1, wherein the amount of Cr is 0.1-1.0.

4. The sawing device according to claim 1, wherein the amount of Ni is 0.5-1.0.

5. The sawing device according to claim 1, wherein the amount of Al is 0-0.3.

6. The sawing device according to claim 1, wherein the amount of Si is 0-0.3.

7. The sawing device according to claim 1, wherein the total amount of Al and Si is ≤0.6 wt. %.

8. The sawing device according to claim 1, wherein the total amount of C, Mn, Cr, Ni, Al, and Si is 1.5-4.0 wt. %

9. (canceled)

10. The sawing device according to claim 1, wherein the steel comprises a wear resistant coating.

11. The sawing device according to claim 10, wherein the sawing device comprises a cutting link for a sawing chain.

12. A method for manufacturing a sawing device comprising the steps:
providing a sawing device manufactured from a steel containing in wt. %:

| | |
|---|---|
| C: | 0.7-1.2 |
| Mn: | 0.2-0.8 |
| Cr: | 0-1.0 |
| Ni: | 0-1.5 |
| Al: | 0-0.5 |
| Si: | 0-0.5 |

wherein the total amount of C, Mn, Cr, Ni, Al, and Si is 1.5-4.5 wt. % and the balance being Fe and incidental elements;
hardening the sawing device by heating to austenitization temperature followed by cooling to an isothermal temperature to obtain a microstructure of bainite or bainite and martensite;
applying a wear resistant coating onto at least a portion of the surface of the sawing device.
